(19) United States
(12) Patent Application Publication
(10) Pub. No.: US 2026/0120122 A1
(43) Pub. Date: Apr. 30, 2026

(54) CONTRIBUTION CALCULATION APPARATUS, CONTRIBUTION CALCULATION METHOD, AND COMPUTER PROGRAM PRODUCT

(71) Applicant: JVCKENWOOD Corporation, Yokohama-shi (JP)

(72) Inventors: Akihide Iwaki, Yokohama-shi (JP); Jiro Uzaki, Yokohama-shi (JP)

(21) Appl. No.: 19/426,470

(22) Filed: Dec. 19, 2025

Related U.S. Application Data
(63) Continuation of application No. PCT/JP2024/013783, filed on Apr. 3, 2024.

(30) Foreign Application Priority Data
Sep. 21, 2023 (JP) 2023-156263

(51) Int. Cl. G06Q 30/018

(52) U.S. Cl. CPC G06Q 30/018

(57) ABSTRACT

A contribution calculation apparatus, a contribution calculation method, and a program, which enable appropriate rating of contributions of creators of individual pieces of content in composite content, are provided. The contribution calculation apparatus according to the present disclosure is a contribution calculation apparatus that calculates contributions of creators of individual pieces of content in composite content that is content having original content and one or more pieces of content different from the original content and superimposed on the original content. The contribution calculation apparatus includes: an obtainment unit that obtains rating factor information representing information for calculating the contributions of the creators of the individual pieces of content in the composite content; and a calculation unit that calculates, on the basis of the rating factor information, the contributions of the creators of the individual pieces of content superimposed on the original content.

### CROSS-REFERENCE TO RELATED APPLICATIONS

This application is a Continuation of PCT International Application No. PCT/JP2024/013783 filed on April 3, 2024 which claims the benefit of priority from Japanese Patent Application No. 2023-156263, filed on September 21, 2023, the entire contents of both of which are incorporated herein by reference.

### BACKGROUND OF THE INVENTION

### 1. Field of the Invention

The present disclosure relates to a contribution calculation apparatus, a contribution calculation method, and a program.

### 2. Description of the Related Art

Content is sometimes created through participation of multiple artists. The spread of the Internet has facilitated combining pieces of content of multiple artists, as well as distributing created content to a large number of users and obtaining responses.

For example, a service provider server is disclosed in Japanese Unexamined Patent Application Publication No. 2012-118776. This service provider server enables users to freely buy and sell content produced by themselves, enables exchanges between users through feedback on the content from buyer users, and enables free buying and selling of derivative content derived from the content within the site to allow the content to grow.

However, although the service provider server described in Japanese Unexamined Patent Application Publication No. 2012-118776 enables a reward to be returned to the creator user who registered the original content of the derivative content, when content created by a plurality of artists generates revenue, knowing which artists contributed more to the revenue and reflecting the artists' contributions in division of the revenue are difficult.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

A contribution calculation apparatus according to the present disclosure that calculates contributions of creators of individual pieces of content in composite content that is content having original content and one or more pieces of content different from the original content and superimposed on the original content, the contribution calculation apparatus comprising: an obtainment unit that obtains rating factor information representing information for calculating the contributions of the creators of the individual pieces in the composite content; and a calculation unit that calculates, on the basis of the rating factor information, the contributions of the creators of the individual pieces of content superimposed on the original content.

A contribution calculation method according to the present disclosure of calculating contributions of creators of individual pieces of content in composite content that is content having original content and one or more pieces of content different from the original content and superimposed on the original content, the contribution calculation method including: a step of obtaining rating factor information representing information for calculating the contributions of the creators of the individual pieces of content in the composite content; and a step of calculating, on the basis of the rating factor information, the contributions of the creators of the individual pieces of content superimposed on the original content.

A computer program product according to the present disclosure having a computer readable medium including a computer program, that causes contributions of creators of individual pieces of content to be calculated, the individual pieces of content being in composite content that is content having original content and one or more pieces of content different from the original content and superimposed on the original content, the computer program product causing a computer to execute: a step of obtaining rating factor information representing information for calculating the contributions of the creators of the individual pieces of content in the composite content; and a step of calculating, on the basis of the rating factor information, the contributions of the creators of the individual pieces of content superimposed on the original content.

### BRIEF DESCRIPTION OF THE DRAWINGS

FIG. 1 is a diagram illustrating an overview of a contribution calculation system according to the present disclosure;

FIG. 2 is a diagram illustrating an example of a configuration of the contribution calculation system according to the present disclosure;

FIG. 3 is a diagram illustrating an example of a configuration of a contribution calculation apparatus according to the present disclosure;

FIG. 4 is a diagram illustrating an example of information stored in a content storage unit of the contribution calculation apparatus according to the present disclosure;

FIG. 5 is a diagram illustrating an example of information stored in a rating factor information storage unit of the contribution calculation apparatus according to the present disclosure;

FIG. 6 is a diagram illustrating an example of tree diagram information obtained by an obtainment unit of the contribution calculation apparatus according to the present disclosure;

FIG. 7 is a diagram illustrating an example of tree diagram information of composite content according to the present disclosure;

FIG. 8 is a diagram illustrating an example of a distribution request reception screen display caused to be displayed, by a reception unit of the contribution calculation apparatus according to the present disclosure;

FIG. 9 is a diagram illustrating an example of a distribution screen caused to be displayed, by a distribution unit of the contribution calculation apparatus according to the present disclosure;

FIG. 10 is a diagram illustrating an example of a configuration of a content distribution apparatus according to the present disclosure; and

FIG. 11 is a diagram illustrating an example of a configuration of a user terminal according to the present disclosure.

### DETAILED DESCRIPTION OF THE PREFERRED EMBODIMENTS

An embodiment of the present disclosure will hereinafter be described in detail, on the basis of the drawings. The present disclosure is not to be limited by the embodiment described hereinafter.

### Overview of Contribution Calculation System

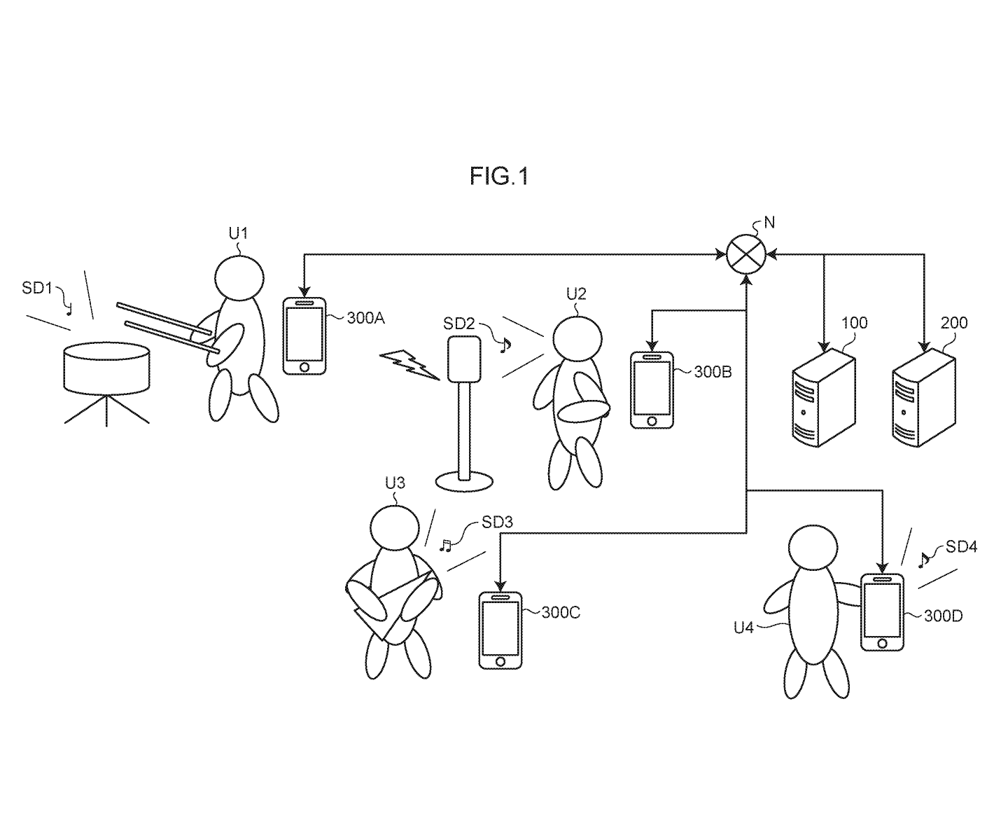

An overview of a contribution calculation system according to the present disclosure will be described first by use of FIG. 1. FIG. 1 is a diagram illustrating the overview of the contribution calculation system according to the present disclosure. As illustrated in FIG. 1, a contribution calculation system 1 according to the present disclosure includes a contribution calculation apparatus 100 that calculates contributions of creators of individual pieces of content in composite content, a content distribution apparatus 200 that distributes the composite content, and a user terminal 300 that obtains content created by a creator.

As illustrated in FIG. 1, for example, a user terminal 300A of a user U1 records sound SD1 of the user U1's drum performance. A user terminal 300B of a user U2 records sound SD2 of the user U2's singing voice from a microphone via, for example, wireless communication. A user terminal 300C of a user U3 records sound SD3 of the user U3's guitar performance. The user terminals 300A, 300B, and 300C then respectively transmit the recorded sound SD1, sound SD2, and sound SD3 to the contribution calculation apparatus 100 via a network N.

The contribution calculation apparatus 100 generates new composite content by superimposing the sound SD1, the sound SD2, and the sound SD3 obtained from the user terminals 300A, 300B, and 300C on one another. On the basis of a request from a user terminal 300D of a user U4, for example, the contribution calculation apparatus 100 may distribute the composite content to the user terminal 300D and cause the user terminal 300D to output sound SD4 of the composite content. Separately from the contribution calculation apparatus 100, the content distribution apparatus 200, which is a dedicated server apparatus for distributing the composite content, may be provided, the content distribution apparatus 200 may obtain the composite content generated by the contribution calculation apparatus 100, and the content distribution apparatus 200 may distribute the composite content to the user terminals 300A, 300B, 300C, and 300D on the basis of requests from the user terminals 300A, 300B, 300C, and 300D.

On the basis of a distribution status of the composite content and user responses received by the content distribution apparatus 200, for example, the contribution calculation apparatus 100 calculates contributions of the users U1, U2, and U3, who are artists, to the composite content. The contributions calculated by the contribution calculation apparatus 100 are used in division of revenue obtained by the distribution of the composite content.

### Configuration of Contribution Calculation System

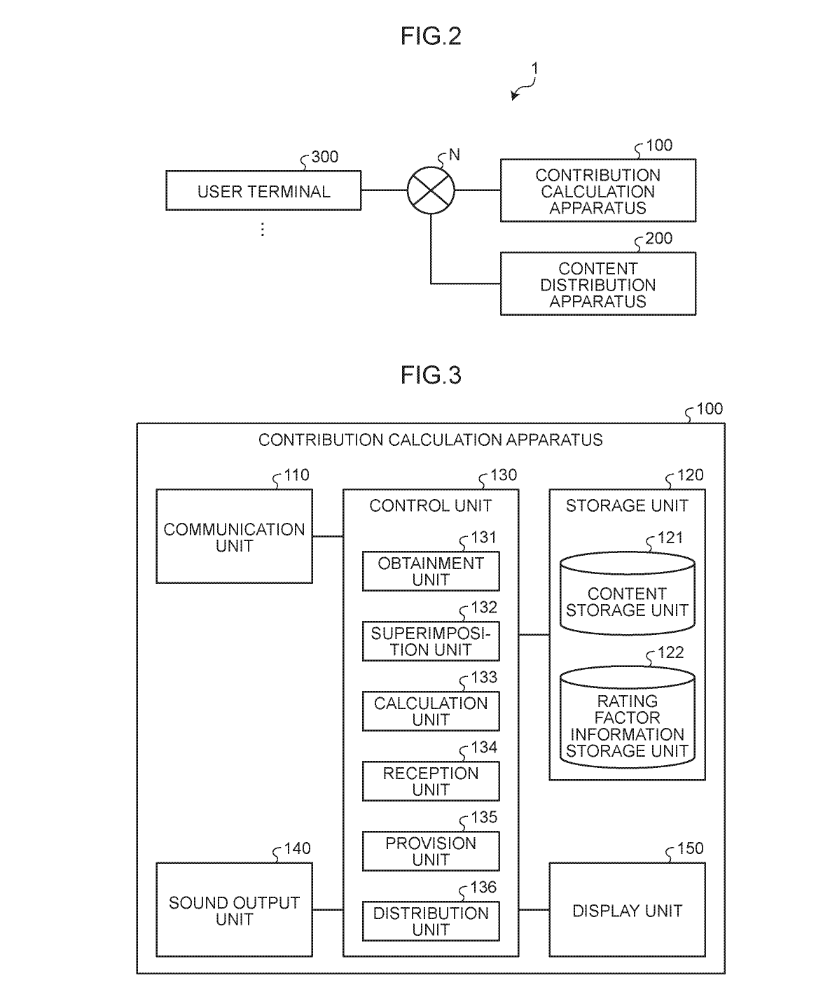

A configuration of the contribution calculation system 1 according to the present disclosure will be described next by use of FIG. 2. FIG. 2 is a diagram illustrating an example of a configuration of the contribution calculation system according to the present disclosure. As illustrated in FIG. 2, the contribution calculation system 1 according to the present disclosure has the contribution calculation apparatus 100, the content distribution apparatus 200, and the user terminal 300. These components will hereinafter be described briefly.

The contribution calculation apparatus 100 is an information processing apparatus that executes various information processing, such as processing of calculating contributions of individual artists to composite content having a plurality of pieces of content superimposed on one another. For example, on the basis of information transmitted from the content distribution apparatus 200 or the user terminal 300 via the network N, the contribution calculation apparatus 100 executes the processing. The contribution calculation apparatus 100 may be implemented by, for example, an information processing apparatus, such as a personal computer (PC), a workstation (WS), or a computer including functions of a server.

The content distribution apparatus 200 is an information processing apparatus that executes various information processing, such as distribution of composite content and content. For example, on the basis of information transmitted from the contribution calculation apparatus 100 or the user terminal 300 via the network N, the content distribution apparatus 200 executes processing. The content distribution apparatus 200 may be implemented by, for example, an information processing apparatus, such as a PC, a WS, or a computer including functions of a server.

The user terminal 300 is an information processing device used by a user. For example, the user terminal 300 may be an information processing device, such as a smartphone, a tablet terminal, a wearable device, a mobile phone, or a personal digital assistant (PDA). FIG. 1 illustrates an example of a case where the user terminal 300 is a smartphone.

The network N connects the contribution calculation apparatus 100, the content distribution apparatus 200, and the user terminal 300, communicably to one another by wire or wirelessly. In a case where the network N is wired, the network N may be implemented by ETHERNET (registered trademark) as defined by IEEE 802.3. In a case where the network N is wireless, the network N may be implemented by a wireless local area network (LAN) as defined by IEEE 802.11 or Bluetooth (registered trademark)

### Configuration of Contribution Calculation Apparatus

A configuration of the contribution calculation apparatus 100 according to the present disclosure will be described next by use of FIG. 3. FIG. 3 is a diagram illustrating an example of a configuration of a contribution calculation apparatus according to the present disclosure. As illustrated in FIG. 3, the contribution calculation apparatus 100 according to the present disclosure includes a communication unit 110, a storage unit 120, a control unit 130, a sound output unit 140, and a display unit 150. These components will hereinafter be described in sequence.

### Re Communication Unit 110

The communication unit 110 is a communication module through which the contribution calculation apparatus 100 performs communication with an external apparatus. The communication unit 110 handles transmission and reception of various data to and from the external apparatus by wireless communication or wired communication. For the wireless communication, the communication unit 110 may include a communication antenna, or a communication processing circuit, such as a radio frequency (RF) circuit or a wireless local area network (LAN) card. For the wired communication, for example, the communication unit 110 may include a network interface card (NIC) including a wired LAN terminal, a transmission circuit, or any other communication processing circuit.

### Re Storage Unit 120

The storage unit 120 is a storage device that stores various information. The storage unit 120 includes a main storage device and an auxiliary storage device. The main storage device may be implemented by, for example, a semiconductor memory element, such as a random access memory (RAM), a read only memory (ROM), or a flash memory. The auxiliary storage device may be implemented by, for example, a hard disk, a solid state drive (SSD), or an optical disk.

As illustrated in FIG. 3, the storage unit 120 includes a content storage unit 121 and a rating factor information storage unit 122. An example of information stored by these components will hereinafter be described in sequence.

### Re Content Storage Unit 121

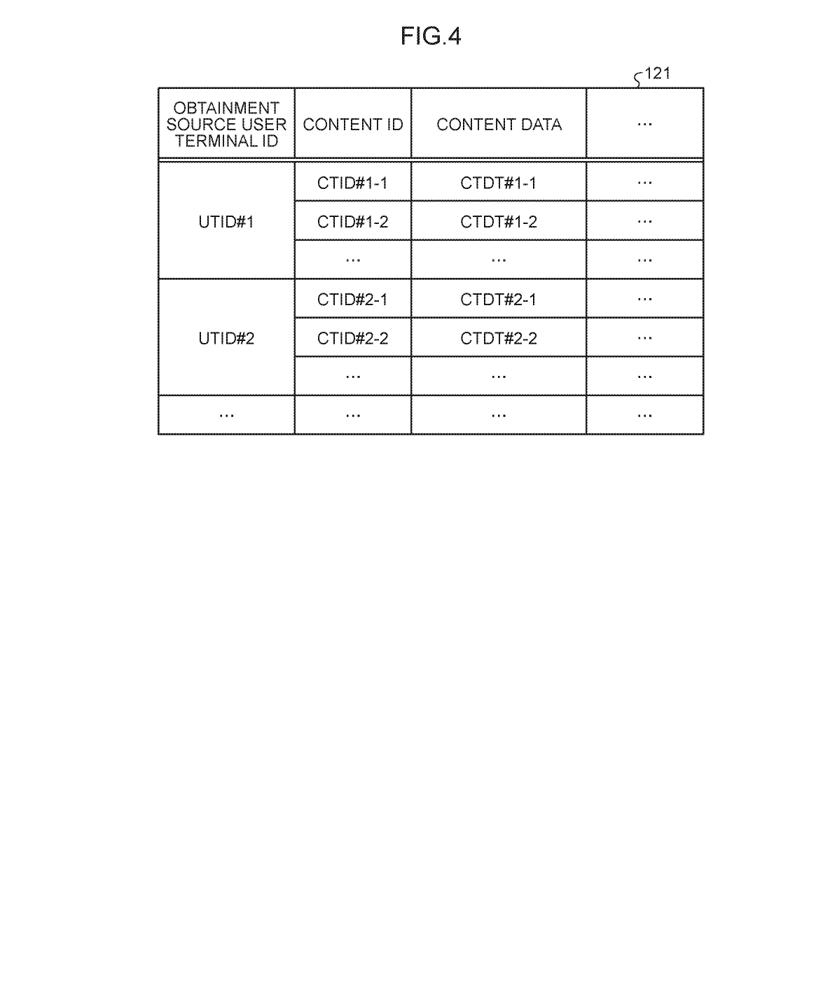

The content storage unit 121 stores information related to content. An example of information stored in the content storage unit 121 will be described now by use of FIG. 4. FIG. 4 is a diagram illustrating an example of information stored in a content storage unit of the contribution calculation apparatus according to the present disclosure.

In the example illustrated in FIG. 4, the content storage unit 121 stores pieces of information related to items, such as "obtainment source user terminal ID", "content ID", and "content data", in association with one another.

"Obtainment source user terminal ID" corresponds to identifiers identifying user terminals 300 from which content data are obtained and is represented by character strings or numbers, for example. "Content ID" corresponds to identifiers identifying pieces of content and is represented by character strings or numbers, for example. "Content data" corresponds to data of the pieces of content identified by "content ID" and is, for example, sound source data and video data.

That is, FIG. 4 illustrates that content data of a piece of content identified by a content ID, "CTID#1-1", obtained from a user terminal 300 identified by an obtainment source user terminal ID, "UTID#1", are "CTDT#1-1".

The information stored in the content storage unit 121 is not to be limited to the information related to the items, "obtainment source user terminal ID", "content ID", and "content data", and any other information related to content may be stored therein.

### Re Rating Factor Information Storage Unit 122

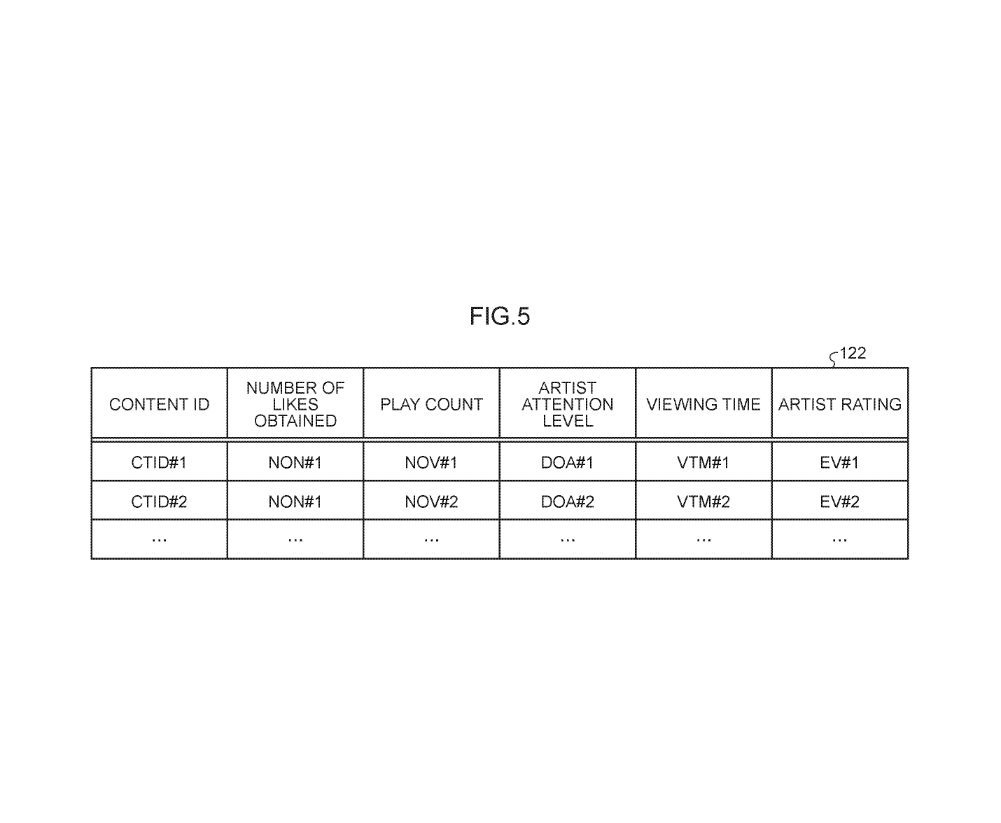

The rating factor information storage unit 122 stores information related to rating factor information indicating information for calculating contributions of creators of individual pieces of content in composite content. An example of information stored in the rating factor information storage unit 122 will now be described by use of FIG. 5. FIG. 5 is a diagram illustrating an example of information stored in a rating factor information storage unit of the contribution calculation apparatus according to the present disclosure.

In the example illustrated in FIG. 5, the rating factor information storage unit 122 stores pieces of information related to items, "content ID, "number of likes obtained", "play count", "artist attention level", "viewing time", and "artist rating", in association with one another.

"Content ID" corresponds to identifiers identifying pieces of content targeted by rating factor information and is represented by character strings or numbers, for example. "Number of likes obtained" is information indicating the numbers of times a "like" was given by users for the pieces of content identified by "content ID".

"Play count" is information indicating the numbers of times the pieces of content identified by "content ID" have been played. "Artist attention level" is information indicating attention levels for artists of the pieces of content identified by "content ID" and may be said to be topicality of well-known artists and trending artists, and ranks are determined according to the numbers of web searches. "Viewing time" is information indicating viewing times of the pieces of content identified by "content ID". "Artist rating" is information indicating the numbers of ratings, such as "likes", given by all of artists involved in creating the pieces of content identified by "content ID" to the pieces of content identified by "content ID".

That is, FIG. 5 illustrates that a piece of content identified by a content ID, "CTID#1", has been given the number of likes indicated by the number of likes obtained, "NON#1", and has been played for the number of times indicated by a play count, "NOV#1; an artist of the piece of content has obtained an attention level indicated by an artist attention level, "DOA#1"; the piece of content has been viewed for a time indicated by a viewing time, "VTM#1"; and the piece of content has been given a rating indicated by an artist rating, "EV#1", by artists.

The information stored in the rating factor information storage unit 122 is not to be limited to the information related to the items, "content ID", "number of likes obtained", "play count", "artist attention level", "viewing time", and "artist rating", and any other information related to rating factor information may be stored therein.

### Re Control Unit 130

The control unit 130 will be described next by reference to FIG. 3 again. The control unit 130 is a controller that governs and controls the contribution calculation apparatus 100. The control unit 130 is implemented by, for example, a central processing unit (CPU) or a microprocessing unit (MPU) executing various programs stored in the storage unit 120, with a RAM serving as a work area. The control unit 130 may be implemented by, for example, an integrated circuit, such as an application specific integrated circuit (ASIC) or a field programmable gate array (FPGA).

As illustrated in FIG. 3, the control unit 130 includes an obtainment unit 131, a superimposition unit 132, a calculation unit 133, a reception unit 134, a provision unit 135, and a distribution unit 136. The control unit 130 reads and executes programs (software) from the storage unit 120 and thereby implements their functions and executes their processes. The functions of the control unit 130 may be implemented by an electronic circuit. The control unit 130 may execute the processes by means of a single CPU or may include a plurality of CPUs and execute the processes in parallel by means of the plurality of CPUs. These components will hereinafter be described in sequence.

The obtainment unit 131 obtains various information from the inside or outside of the contribution calculation apparatus 100. An example of information obtained by the obtainment unit 131 will be described hereinafter.

For example, the obtainment unit 131 obtains content data. For example, the obtainment unit 131 obtains content data from the user terminal 300. When the obtainment unit 131 has obtained the content data from the user terminal 300, the obtainment unit 131 stores the obtained content data into the content storage unit 121. The content data herein may be, for example, data of a piece of music provided by an artist or a person who wishes to create music. The piece of music may be a piano performance or a performance involving a plurality of instruments. The music data may be, for example, sound source data in a format, such as RIFF Waveform Audio Format (WAV) or MPEG-1 Audio Layer-3 (MP3), but the format of the music data is not to be limited to these examples. The content data may be data that serve as a trigger for music creation, such as a photograph, a video, or a novel.

The obtainment unit 131 also obtains rating factor information indicating information for calculating contributions of creators of individual pieces of content in composite content. Specifically, the obtainment unit 131 obtains rating factor information from the content distribution apparatus 200. The obtainment unit 131 may obtain rating factor information from the user terminal 300.

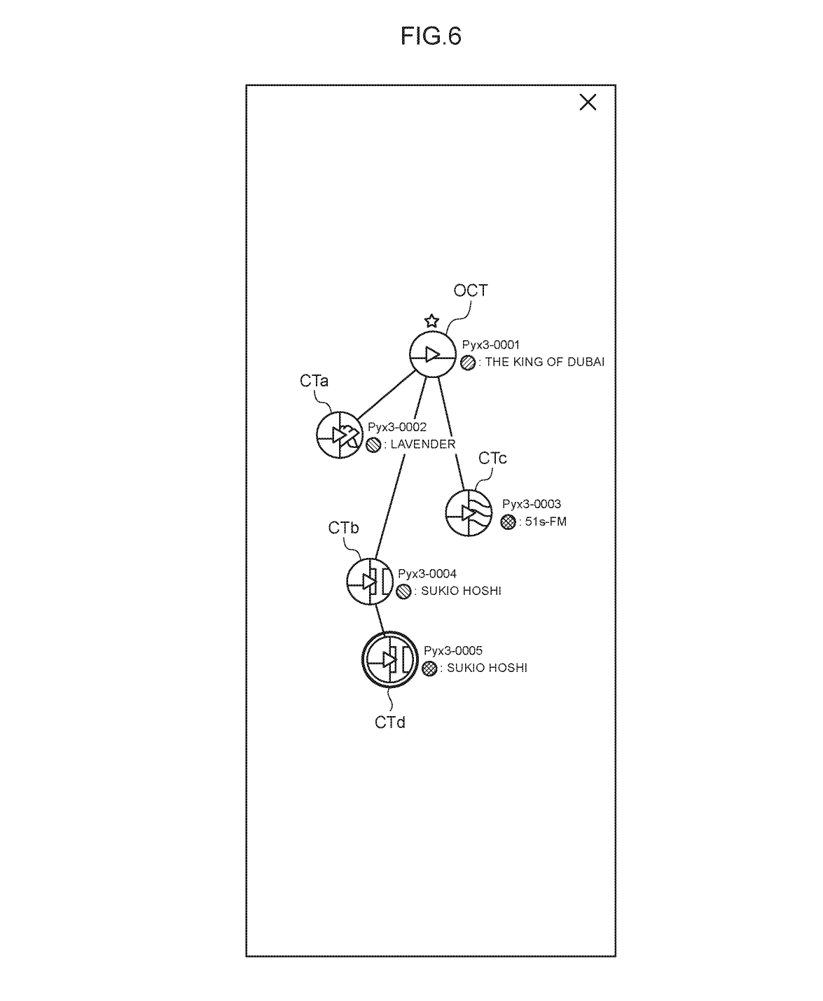

For example, the obtainment unit 131 obtains, as the rating factor information, information related to a tree diagram indicating relations among the individual pieces of content in the composite content. Three diagram information is information indicating relations among individual pieces of content by means of a tree diagram, as illustrated in FIG. 6. FIG. 6 is a diagram illustrating an example of tree diagram information obtained by an obtainment unit of the contribution calculation apparatus according to the present disclosure. As illustrated in FIG. 6, the tree diagram information is information indicating relations between original content OCT of composite content and individual pieces of content CTa, CTb, CTc, and CTd superimposed on the original content OCT, by means of a tree diagram. FIG. 6 illustrates that the pieces of content CTa, CTb, and CTc have been superimposed on the original content OCT and the piece of content CTd has been further superimposed on content having the piece of content CTb superimposed on the original content OCT.

Furthermore, as the rating factor information, the obtainment unit 131 further obtains user rating information indicating individual users' ratings for the composite content. The user rating information is the individual users' ratings for the composite content and is, for example, the number of "like" ratings given by the users to the composite content or to the individual pieces of content included in the composite content, when a specific time period in which the composite content that is in the creation process or that has been completed is made public is provided.

The obtainment unit 131 further obtains, as the rating factor information, individual play count information indicating individual play counts of the individual pieces of content in the composite content. The individual play count information indicates the individual play counts of the individual pieces of content in the composite content, and when the composite content is made public, the individual pieces of content included in the composite content are also made public and the numbers of times the users play them are recorded.

The superimposition unit 132 generates composite content having a plurality of pieces of content superimposed on one another. For example, the superimposition unit 132 receives original content and specified content to be superimposed thereon and superimposes the specified content on the original content. That is, the superimposition unit 132 superimposes content of the same artist as the original content or content of a different artist, on the original content. The superimposition unit 132 may receive input of next content that is content desired to be further superimposed on pieces of content that have been superimposed on one another and further superimpose the next content thereon. Repeating this superimposition of content on the original content enables composite content to be generated.

On the basis of rating factor information, the calculation unit 133 calculates contributions of creators of individual pieces of content superimposed on original content. A specific process in which the calculation unit 133 calculates the contributions of the creators of the individual pieces of content will be described hereinafter.

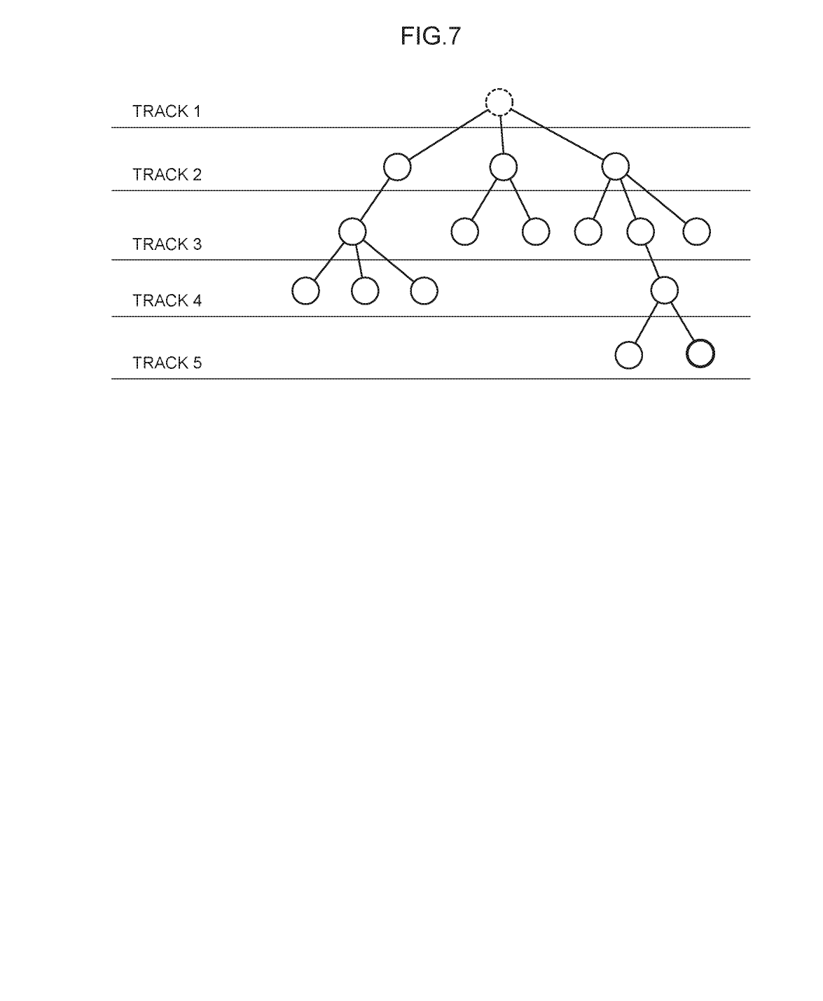

On the basis of information related to a tree diagram, the calculation unit 133 calculates the numbers of pieces of content further superimposed on the individual pieces of content, and on the basis of the numbers of these pieces of content, the calculation unit 133 calculates first contribution ratings that are contributions of the creators of the individual pieces of content. By using indicators that are the numbers of connections branching out from the individual pieces of content, the calculation unit 133 calculates the first contribution ratings as: Rating of piece of content A = Number of connections from piece of content A/(Total number of connections to last piece of content + 1). A case where composite content has tree diagram information illustrated in FIG. 7 will now be described, for example. FIG. 7 is a diagram illustrating an example of tree diagram information of composite content according to the present disclosure. The last piece of content is represented by a bold circle in FIG. 7. In FIG. 7, three sound sources are connected from a track 1 including a sound source, which is an example of content, and three sound sources are connected also from a track 2. One sound source is connected from a track 3 and two sound sources are connected from a track 4. That is, the total number of connections to the last piece of content from the first piece of content to the last piece of content is 9 (= 3 + 3 + 1 + 2). By using, as the denominator, 10 resulting from addition of 1 for the first piece of content to the total number of connections to the last piece of content, first contribution ratings for the tracks in FIG. 7 are calculated as 3/10, 3/10, 1/10, 2/10, and 1/10 in order from the track 1. Calculating the first contribution ratings in this way enables the indicators to be reflected in the ratings, the indicators indicating which pieces of content of the tracks had large influences in the process leading to the last piece of content.

Or the calculation unit 133 may calculate first contribution ratings as: Rating of piece of content A = Number of connections from piece of content A/(Total number of connections in composite content + 1) + (((Total number of connections in composite content + 1) - Total number of connections to last piece of content)/Number of tracks to last piece of content)/(Number of connections in composite content + 1). The case where composite content has the tree diagram information illustrated in FIG. 7 will now be described, for example. In FIG. 7, the total number of connections in the composite content connected, starting from the track 1 including a sound source, which is an example of content, is 15. By using, as the denominator, 16 resulting from addition of the first piece of content to the total number of connections in the composite component, first contribution ratings for the tracks including the sound sources in FIG. 7, the sound sources being examples of pieces of content, are calculated as 4.4/16, 4.4/16, 2.4/16, 3.4/16, and 1.4/16 in order from the track 1. Calculating the first contribution ratings in this way enables equalization of a rating of any piece of content to which a plurality of pieces of content were not connected in the process leading to the last piece of content.

On the basis of the user rating information, the calculation unit 133 calculates second contribution ratings that are contributions of the creators of the individual pieces of content. That is, the calculation unit 133 calculates the second contribution ratings having the user rating information reflected in the first contribution ratings. That is, a specific time period in which the composite content in the creation process or the composite content that has been completed is made public is provided, and the user rating information is reflected, the user rating information indicating the number of ratings, such as "likes" or "nice", given by users to each piece of content. For example, in a case where about 20% of user ratings is desired to be reflected in the first contribution ratings, the second contribution ratings are calculated as follows: Second contribution rating = (First contribution ratings × 0.8) + (User rating information of piece of content A/User rating information of last piece of content) × 0.2.

On the basis of the individual play count information, the calculation unit 133 calculates third contribution ratings that are contributions of the creators of the individual pieces of content. That is, the calculation unit 133 calculates the third contribution ratings having the individual play count information reflected in the first contribution ratings. That is, a specific time period in which the composite content in the creation process or the composite content that has been completed is made public is provided, and the number of times each piece of content has been played by users is reflected. For example, in a case where about 20% of play counts is desired to be reflected in the first contribution ratings, the calculation unit 133 calculates the third contribution ratings as follows: Third contribution rating = (First contribution rating × 0.8) + (Play count of piece of content A/Total number of plays to last piece of content) × 0.2.

On the basis of artist attention level information, the calculation unit 133 calculates fourth contribution ratings that are contributions of the creators of the individual pieces of content. That is, the calculation unit 133 reflects attention levels for the artists who have created the individual pieces of content in the first contribution ratings. For example, topicality of well-known artists and trending artists is reflected as attention levels. Ranks for popularity and topicality are determined by assessing trend levels of the artists using the numbers of web searches, for example. For example, the ranks consist of three levels and are assigned such that high popularity and topicality correspond to 3, low popularity and topicality correspond to 2, and little-known artists corresponds to 1. In a case where about 20% of the artist attention levels is desired to be reflected in the first contribution ratings, the calculation unit 133 calculates the fourth contribution ratings as follows: Fourth contribution rating = (First contribution rating × 0.8) + (Rank of piece of content A/Total number of ranks to last piece of content) × 0.2.

The calculation unit 133 calculates contributions of the creators of the individual pieces of contents as fifth contribution ratings on the basis of viewing times of the pieces of content. That is, the calculation unit 133 reflects the viewing times of the individual pieces of content in the first contribution ratings. For example, in a case where about 20% of the viewing times is desired to be reflected in the first contribution ratings, the calculation unit 133 calculates the fifth contribution ratings as follows: Fifth contribution rating = (First contribution rating × 0.8) + (Length of piece of content A/Total number of viewing times to last piece of content) × 0.2.

On the basis of artist ratings, the calculation unit 133 calculates sixth contribution ratings that are contributions of the creators of the individual pieces of content. That is, the calculation unit 133 reflects, in the first contribution ratings, the numbers of ratings, such as "likes" or "nice", given to pieces of content connected to the last piece of content by an artist or artists related to the last piece of content or all of the artists who have created the pieces of content connected from the original content. For example, in a case where about 20% of the artist ratings is desired to be reflected in the first contribution ratings, the calculation unit 133 may calculate the sixth contribution ratings as follows: Sixth contribution rating = (First contribution rating × 0.8) + (number of likes given to piece of content A/Total number of likes given to last piece of content) × 0.2.

Furthermore, an artist who has participated in creation of a piece of content may be assigned the number of "like" ratings, on the basis of the number of pieces of content connected to the piece of content created by the artist. For example, three "likes" can be assigned as an artist rating to an artist having three pieces of content connected to a piece of content that has been added by the artist even if the piece of content that has been added by the artist is not connected to the last piece of content. In this assignment, three "likes" may be assigned to the same piece of content or one "like" may be assigned to each of the three pieces of content.

By using, as artist ratings, coins obtainable through payments and usable only within a service, the calculation unit 133 may calculate seventh contribution ratings that are contributions of the creators of the individual pieces of content, on the basis of the numbers of coins received from users who have viewed the individual pieces of content. For example, in a case where about 20% of the artist ratings is desired to be reflected in the first contribution ratings, the calculation unit 133 calculates the seventh contribution ratings as follows: Seventh contribution rating = (First contribution rating × 0.8) + (Number of coins for piece of content A/Total number of coins to last piece of content) × 0.2.

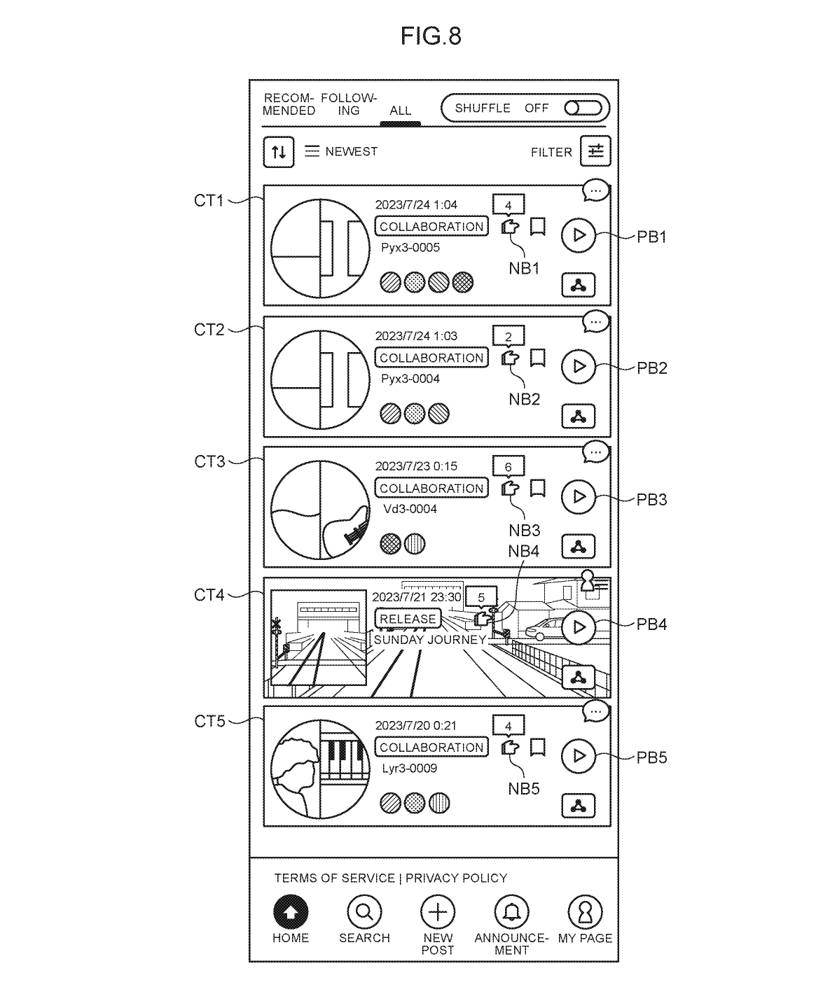

The reception unit 134 receives a distribution request for content from a user. The distribution request may include information related to the user terminal ID of the transmission source of the distribution request and the content ID of the content requested to be distributed. Upon receipt of the distribution request for the content, the reception unit 134 requests the distribution unit 136 to distribute the content, for which the distribution request has been received. For example, the reception unit 134 may cause the user terminal 300 to display a distribution request reception screen illustrated in FIG. 8 and receive a distribution request for content from a user. FIG. 8 is a diagram illustrating an example of a distribution request reception screen caused to be displayed by a reception unit of the contribution calculation apparatus according to the present disclosure. As illustrated in FIG. 8, the reception unit 134 may cause a display unit 350 of the user terminal 300 to display a distribution request reception screen for content CT1, content CT2, content CT3, content CT4, and content CT5 and receive, as distribution requests for the content from a user, the user's touch operations on respective play buttons PB1, PB2, PB3, PB4, and PB5. When the reception unit 134 has distributed the content to the user terminal 300, the reception unit 134 records a play count into the rating factor information storage unit 122.

Furthermore, the reception unit 134 receives reaction information for content from a user. For example, the reception unit 134 causes the user terminal 300 to display the distribution request reception screen illustrated in FIG. 8 and receives the reaction information for the content. As illustrated in FIG. 8, the reception unit 134 causes the display unit 350 of the user terminal 300 to display like buttons NB1, NB2, NB3, NB4, and NB5 for the content CT1, content CT2, content CT3, content CT4, and content CT5, on the distribution request reception screen for the respective content and receives reaction information on likes for the content from a user. When the reception unit 134 receives a like for content, the reception unit 134 records the number of likes into the rating factor information storage unit 122.

The provision unit 135 provides composite content generated by the superimposition unit 132, to the content distribution apparatus 200. That is, the provision unit 135 provides the composite content to the content distribution apparatus 200 via the network N. The provision unit 135 may provide composite content to the content distribution apparatus 200 every time the composite content is generated by the superimposition unit 132 or may provide composite content to the content distribution apparatus 200 when the amount of data of the composite content generated by the superimposition unit 132 exceeds a predetermined amount.

On the basis of a distribution request received by the reception unit 134 from a user, the distribution unit 136 distributes content to the user terminal 300. That is, the distribution unit 136 reads content data for the content matching a content ID included in the distribution request, from the content storage unit 121 and distributes the content data to the user terminal 300, from which the distribution request has been received.

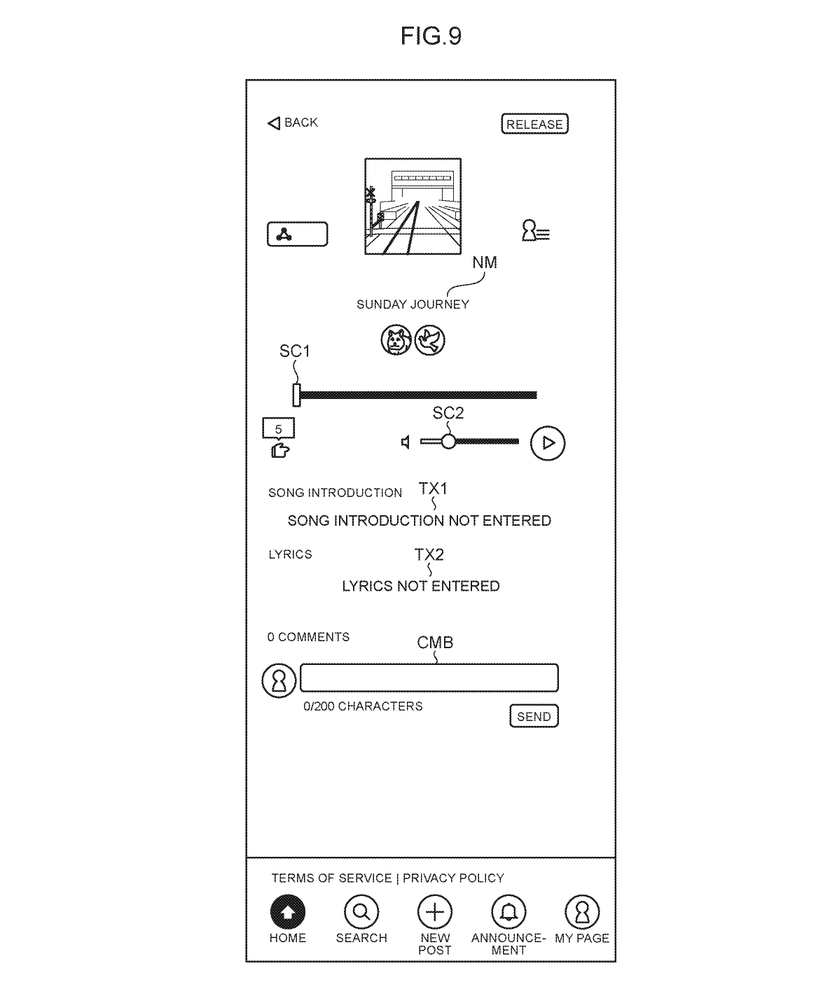

For example, the distribution unit 136 may provide content to a user by causing the user terminal 300 to display a distribution screen illustrated in FIG. 9. FIG. 9 is a diagram illustrating an example of a distribution screen that a distribution unit of the contribution calculation apparatus according to the present disclosure causes to be displayed. As illustrated in FIG. 9, the distribution unit 136 may provide content to a user by causing a name NM of the content, a scroll bar SC1 indicating a play position within the entire content, a scroll bar SC2 for adjusting the volume of sound, text TX1 for introducing the song, text TX2 of the lyrics , and a reception box CMB for comments from users, to be displayed and the sound of the content to be output from a sound input and output unit 340. When the distribution unit 136 receives an operation to stop playing the content from the user, the distribution unit 136 records the viewing time of the content into the rating factor information storage unit 122.

The sound output unit 140 outputs various sound. For example, the sound output unit 140 may output sound of content. The sound output unit 140 may be a speaker, which converts an electric signal to sound by means of a diaphragm. That is, on the basis of a control command provided by the electric signal, the speaker vibrates the diaphragm at a predetermined amplitude and a predetermined frequency and thereby vibrates the air in contact with the diaphragm to output the sound.

The display unit 150 displays various information. For example, the display unit 150 may display a graphical user interface (GUI) for executing various processes at the contribution calculation apparatus 100. The display unit 150 may be implemented by a liquid crystal display, an organic electroluminescence (EL) display, or a micro light emitting diode (LED) display, for example.

### Configuration of Content Distribution Apparatus

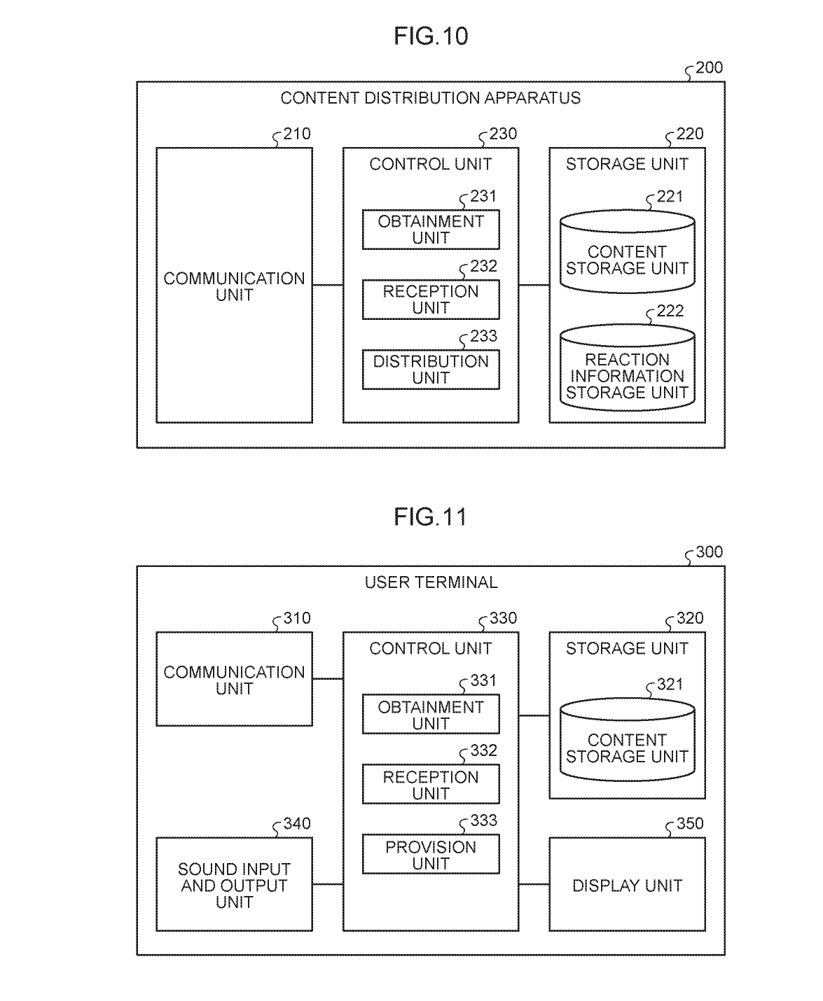

A configuration of the content distribution apparatus 200 according to the present disclosure will be described next by use of FIG. 10. FIG. 10 is a diagram illustrating an example of a configuration of the content distribution apparatus according to the present disclosure. As illustrated in FIG. 10, the content distribution apparatus 200 according to the present disclosure includes a communication unit 210, a storage unit 220, and a control unit 230. These components will hereinafter be described in sequence.

The communication unit 210 is a communication module through which the content distribution apparatus 200 performs communication with an external apparatus. The communication unit 210 handles transmission and reception of data to and from the external apparatus via wireless communication or wired communication. For the wireless communication, the communication unit 210 may include a communication antenna or another communication processing circuit, such as an RF circuit or a wireless LAN card. For the wired communication, for example, the communication unit 210 may include an NIC including a wired LAN terminal, a transmission circuit, or another communication processing circuit.

The storage unit 220 is a storage device that stores various information. The storage unit 220 includes a main storage device and an auxiliary storage device. The main storage device may be implemented by, for example, a semiconductor memory element, such as a RAM, a ROM, or a flash memory. The auxiliary storage device may be implemented by, for example, a hard disk, an SSD, or an optical disk.

As illustrated in FIG. 10, the storage unit 220 includes a content storage unit 221 and a reaction information storage unit 222. Information stored in these components will hereinafter be described in sequence.

The content storage unit 221 stores information related to content. The content storage unit 221 stores composite content having a plurality of pieces of content superimposed on one another, together with tree diagram information. Any other information stored in the content storage unit 221 is the same as the information stored in the content storage unit 121 of the contribution calculation apparatus 100 described already, and description of details of an example of the information stored in the content storage unit 221 will thus be omitted.

The reaction information storage unit 222 stores reaction information indicating responses from users to content. For example, the reaction information storage unit 222 stores "number of likes obtained", "play count", "artist attention level", "viewing time", and "artist rating", which serve as rating factor information. These pieces of information are the same as the pieces of information stored in the rating factor information storage unit 122 of the contribution calculation apparatus 100 described already, and description thereof will thus be omitted.

The control unit 230 is a controller that governs and controls the content distribution apparatus 200. The control unit 230 is implemented by a CPU or an MPU executing various program stored in the storage unit 220, with a RAM serving as a work area. The control unit 230 may be implemented by, for example, an integrated circuit, such as an ASIC or an FPGA.

As illustrated in FIG. 10, the control unit 230 includes an obtainment unit 231, a reception unit 232, and a distribution unit 233. By reading and executing the programs (software) from the storage unit 220, the control unit 230 implements their functions and executes their processes. The functions of the control unit 230 may be implemented by an electronic circuit. The control unit 230 may execute the processes by means of a single CPU or may include a plurality of CPUs and the plurality of CPUs may execute the processes in parallel. These components will hereinafter be described in sequence.

The obtainment unit 231 obtains composite content from the contribution calculation apparatus 100. That is, the obtainment unit 231 obtains the composite content provided by the provision unit 135 of the contribution calculation apparatus 100 and stores the composite content obtained, into the content storage unit 221.

The reception unit 232 receives a distribution request for content from the user terminal 300. The distribution request may include a user terminal ID of a transmission source of the distribution request and information related to a content ID of the content requested to be distributed. When the reception unit 232 receives the distribution request for content, the reception unit 232 requests the distribution unit 233 to distribute the content, for which the distribution request has been received.

Furthermore, the reception unit 232 receives likes from users for content. For example, the reception unit 232 causes the user terminal 300 to display the distribution request reception screen illustrated in FIG. 8 and receives likes for content. A process in which the reception unit 232 receives a like for content from a user is the same as the process by the reception unit 134 of the contribution calculation apparatus 100 described already, and description thereof will thus be omitted.

On the basis of a distribution request received by the reception unit 232 from a user, the distribution unit 233 distributes content to the user terminal 300. That is, the distribution unit 233 reads content data of the content matching a content ID included in the distribution request, from the content storage unit 221, and distributes the content data to the user terminal 300, from which the distribution request has been received.

### Configuration of User Terminal

A configuration of the user terminal 300 according to the present disclosure will be described next by use of FIG. 11. FIG. 11 is a diagram illustrating an example of a configuration of a user terminal according to the present disclosure. As illustrated in FIG. 11, the user terminal 300 according to the present disclosure includes a communication unit 310, a storage unit 320, a control unit 330, the sound input and output unit 340, and the display unit 350. These components will hereinafter be described in sequence.

The communication unit 310 is a communication module through which the user terminal 300 performs communication with an external apparatus. The communication unit 310 handles transmission and reception of data to and from the external apparatus via wireless communication or wired communication. For the wireless communication, the communication unit 310 may include a communication antenna or another communication processing circuit, such as an RF circuit or a wireless LAN card. For the wired communication, for example, the communication unit 310 may include an NIC including a wired LAN terminal, a transmission circuit, or another communication processing circuit.

The storage unit 320 is a storage device that stores various information. The storage unit 320 includes a main storage device and an auxiliary storage device. The main storage device may be implemented by, for example, a semiconductor memory element, such as a RAM, a ROM, or a flash memory. The auxiliary storage device may be implemented by, for example, a hard disk, an SSD, or an optical disk.

As illustrated in FIG. 11, the storage unit 320 includes a content storage unit 321. Information stored by this component will be described hereinafter.

The content storage unit 321 stores information related to content created by a user. The information stored in the content storage unit 321 is the same as the information stored in the content storage unit 121 of the contribution calculation apparatus 100, and description of details of the information stored in the content storage unit 321 will thus be omitted.

The control unit 330 is a controller that governs and controls the user terminal 300. The control unit 330 is implemented by a CPU or an MPU executing various program stored in the storage unit 320, with a RAM serving as a work area. The control unit 330 may be implemented by, for example, an integrated circuit, such as an ASIC or an FPGA.

As illustrated in FIG. 11, the control unit 330 includes an obtainment unit 331, a reception unit 332, and a distribution unit 333. By reading and executing the programs (software) from the storage unit 320, the control unit 330 implements their functions and executes their processes. The functions of the control unit 330 may be implemented by an electronic circuit. The control unit 330 may execute the processes by means of a single CPU or may include a plurality of CPUs and the plurality of CPUs may execute the processes in parallel. These components will hereinafter be described in sequence.

The obtainment unit 331 obtains content from a user. For example, the obtainment unit 331 obtains, as the content, voice input via the sound input and output unit 340 described later. For example, the obtainment unit 331 may obtain content input via the communication unit 310.

The reception unit 332 receives a distribution request for content from a user. For example, the reception unit 332 may cause the display unit 350 to display the distribution request reception screen illustrated in FIG. 8 and receive a distribution request for content from a user. The process of displaying the distribution request reception screen illustrated in FIG. 8 and receiving the distribution request for the content from the user is the same as the process by the reception unit 134 of the contribution calculation apparatus 100 described already, and description thereof will thus be omitted.

The distribution unit 333 distributes content to a user. For example, the distribution unit 333 may provide the content to the user by causing the sound input and output unit 340 to output sound of the content distributed from the contribution calculation apparatus 100 or content distribution apparatus 200 and causing the display unit 350 to display a distribution screen for the content and a video of the content.

The sound input and output unit 340 outputs various sound. That is, the sound input and output unit 340 has functions of a microphone and functions of a speaker. For example, the sound input and output unit 340 may output sound of content. The sound input and output unit 340 may receive input of voice or sound of a musical instrument performance via the microphone.

The display unit 350 displays various information. For example, the display unit 350 may display a distribution screen for content, a distribution reception screen, and a video of the content. The display unit 350 may be implemented by a liquid crystal display, an organic EL display, or a micro LED display.

### Configurations and Effects

The contribution calculation apparatus 100 according to the present disclosure is the contribution calculation apparatus 100 that calculates contributions of individual pieces of content in composite content that is content having original content and one or more pieces of content different from the original content and superimposed on the original content. The contribution calculation apparatus 100 includes: the obtainment unit 131 that obtains rating factor information representing information for calculating contributions of creators of the individual pieces of content in the composite content; and the calculation unit 133 that calculates, on the basis of the rating factor information, the contributions of the creators of the individual pieces of content superimposed on the original content.

This configuration enables calculation of contributions of creators of individual pieces of content in composite content, which is content having original content and one or more pieces of content different from the original content and superimposed on the original content. Therefore, the contribution calculation apparatus 100, which enables appropriate rating of contributions of creators of individual pieces of content in composite content, is able to be provided.

The obtainment unit 131 of the contribution calculation apparatus 100 according to the present disclosure obtains, as the rating factor information, information related to a tree diagram indicating relations among the individual pieces of content in the composite content, and the calculation unit 133 calculates, on the basis of the information related to the tree diagram, the numbers of pieces of content superimposed further on the individual pieces of content, and calculates, on the basis of the numbers of pieces of content, first contribution ratings that are contributions of the creators of the individual pieces of content.

This configuration enables: calculation of the numbers of pieces of content further superimposed on individual pieces of content on the basis of information related to a tree diagram indicating relations among the individual pieces of content in composite content; and calculation of first contribution ratings that are contributions of creators of the individual pieces of content on the basis of the numbers of pieces of content. Therefore, the contribution calculation apparatus 100, which enables appropriate rating of contributions of creators of individual pieces of content in composite content, is able to be provided.

The obtainment unit 131 of the contribution calculation apparatus 100 according to the present disclosure further obtains, as the rating factor information, user rating information indicating ratings of individual users for the composite content, and the calculation unit 133 calculates, on the basis of the user rating information, second contribution ratings that are contributions of the creators of the individual pieces of content.

This configuration enables calculation of second contribution ratings that are contributions of creators of individual pieces of content, on the basis of user rating information indicating ratings of individual users for composite content. Therefore, the contribution calculation apparatus 100, which enables appropriate rating of contributions of creators of individual pieces of content in composite content, is able to be provided.

The obtainment unit 131 of the contribution calculation apparatus 100 according to the present disclosure further obtains, as the rating factor information, individual play count information indicating individual play counts of the individual pieces of content in the composite content, and the calculation unit 133 calculates, on the basis of the individual play count information, third contribution ratings that are contributions of the creators of the individual pieces of content.

This configuration enables calculation of third contribution ratings that are contributions of creators of individual pieces of content, on the basis of individual play count information indicating individual play counts of the individual pieces of content in composite content. Therefore, the contribution calculation apparatus 100, which enables appropriate rating of contributions of creators of individual pieces of content in composite content, is able to be provided.

A contribution calculation method according to the present disclosure is a contribution calculation method of calculating contributions of individual pieces of content in composite content that is content having original content and one or more pieces of content different from the original content and superimposed on the original content. The contribution calculation method includes a step of obtaining rating factor information representing information for calculating contributions of creators of the individual pieces of content in the composite content, and a step of calculating, on the basis of the rating factor information, the contributions of the creators of the individual pieces of content superimposed on the original content.

The contribution calculation method enables calculation of contributions of creators of individual pieces of content in composite content that is content having original content and one or more pieces of content different from the original content and superimposed on the original content. Therefore, a contribution calculation method, which enables appropriate rating of contributions of creators of individual pieces of content in composite content, is able to be provided.

A program according to the present disclosure is a program that causes contributions of individual pieces of content to be calculated, the individual pieces of content being in composite content that is content having original content and one or more pieces of content different from the original content and superimposed on the original content. The program causes a computer to execute: a step of obtaining rating factor information representing information for calculating contributions of creators of the individual pieces of content in the composite content; and a step of calculating, on the basis of the rating factor information, the contributions of the creators of the individual pieces of content superimposed on the original content.

This program enables calculation of contributions of creators of individual pieces of content in composite content that is content having original content and one or more pieces of content different from the original content and superimposed on the original content. Therefore, a program, which enables appropriate rating of contributions of creators of individual pieces of content in composite content, is able to be provided.

According to the present disclosure, a contribution calculation apparatus, a contribution calculation method, and a program that enable appropriate rating of contributions of creators of individual pieces of content in composite content are able to be provided.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A contribution calculation apparatus that calculates contributions of creators of individual pieces of content in composite content that is content having original content and one or more pieces of content different from the original content and superimposed on the original content, the contribution calculation apparatus comprising:
an obtainment unit that obtains rating factor information representing information for calculating the contributions of the creators of the individual pieces in the composite content; and
a calculation unit that calculates, on the basis of the rating factor information, the contributions of the creators of the individual pieces of content superimposed on the original content.

2. The contribution calculation apparatus according to claim 1, wherein
the obtainment unit obtains, as the rating factor information, information related to a tree diagram indicating relations among the individual pieces of content in the composite content, and
the calculation unit calculates, on the basis of the information related to the tree diagram, the numbers of pieces of content superimposed further on the individual pieces of content, and calculates, on the basis of the numbers of pieces of content, first contribution ratings that are contributions of the creators of the individual pieces of content.

3. The contribution calculation apparatus according to claim 2, wherein
the obtainment unit further obtains, as the rating factor information, user rating information indicating ratings of individual users for the composite content, and
the calculating unit calculates, on the basis of the user rating information, second contribution ratings that are contributions of the creators of the individual pieces of content.

4. The contribution calculation apparatus according to claim 2, wherein
the obtainment unit further obtains, as the rating factor information, individual play count information indicating individual play counts of the individual pieces of content in the composite content, and
the calculation unit calculates, on the basis of the individual play count information, third contribution ratings that are contributions of the creators of the individual pieces of content.

5. A contribution calculation method of calculating contributions of creators of individual pieces of content in composite content that is content having original content and one or more pieces of content different from the original content and superimposed on the original content, the contribution calculation method including:
a step of obtaining rating factor information representing information for calculating the contributions of the creators of the individual pieces of content in the composite content; and
a step of calculating, on the basis of the rating factor information, the contributions of the creators of the individual pieces of content superimposed on the original content.

6. A computer program product according to the present disclosure having a computer readable medium including a computer program, that causes contributions of creators of individual pieces of content to be calculated, the individual pieces of content being in composite content that is content having original content and one or more pieces of content different from the original content and superimposed on the original content, the computer program product causing a computer to execute:
a step of obtaining rating factor information representing information for calculating the contributions of the creators of the individual pieces of content in the composite content; and
a step of calculating, on the basis of the rating factor information, the contributions of the creators of the individual pieces of content superimposed on the original content.
